(19) United States
(12) Patent Application Publication
(10) Pub. No.: US 2017/0185745 A1
(43) Pub. Date: Jun. 29, 2017

(54) Technologies for customized drug provisioning

(71) Applicants: Dan Wartski, Zichron Yaakov (IL); Glen J. Anderson, Beaverton, OR (US); Tamara Gaidar, Haifa (IL); Ido Lapidot, Haifa (IL); Yoram Zahavi, Zichron Yaacov (IL); Maria Bezaitis, Portland, OR (US)

(72) Inventors: Dan Wartski, Zichron Yaakov (IL); Glen J. Anderson, Beaverton, OR (US); Tamara Gaidar, Haifa (IL); Ido Lapidot, Haifa (IL); Yoram Zahavi, Zichron Yaacov (IL); Maria Bezaitis, Portland, OR (US)

(21) Appl. No.: 14/998,269

(22) Filed: Dec. 26, 2015

(51) Int. Cl. G06F 19/00

(52) U.S. Cl. CPC G06F 19/3462; G06F 19/322; G06F 19/3418

(57) ABSTRACT

Technologies for customized drug provisioning include a drug dosage determination server and a drug dispenser device. The drug dosage determination server is configured to obtain patient physiological data associated with a patient, determine a drug dosage for the patient based on the patient physiological data, generate drug dosage instructions for a drug dispenser device, based on the determined drug dosage, and transmit the drug dosage instructions to the drug dispenser device. The drug dispenser device is configured to receive drug dosage instructions from the drug dosage determination server, prompt the patient for authentication credentials, determine whether the patient is authenticated, generate the drug based on the drug dosage instructions in response to a determination that the patient is authenticated, and dispense the drug. Other embodiments are described.

### BACKGROUND

Conventional methods of treating patients with drugs, such as pills, are susceptible to being inaccurate. For example, patients having different ages, weights, and other health-related factors may take essentially the same pill. Further, as conditions that may affect a patient's health can vary as a function of geographic location, season, outbreaks of illnesses, and other factors, the patient's drug prescription generally does change in response to these varying conditions. Rather, the patient continues to consume doses of the drug in accordance with a prescription that was prepared based on conditions that have since changed.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for customized drug provisioning;

FIG. 2 is a simplified block diagram of at least one embodiment of a drug dosage determination server of the system of FIG. 1;

FIG. 3 is a simplified block diagram of at least one embodiment of a drug dispenser device of system of FIG. 1;

FIG. 4 is a simplified block diagram of at least one embodiment of an environment that may be established by the drug dosage determination server of FIGS. 1 and 2;

FIG. 5 is a simplified block diagram of at least one embodiment of an environment that may be established by the drug dispenser device of FIGS. 1 and 3;

FIGS. 6-8 are a simplified flow diagram of at least one embodiment of a method for determining a drug dosage for a patient that may be executed by the drug dosage determination server of FIGS. 1 and 2; and

FIGS. 9-10 are a simplified flow diagram of at least one embodiment of a method for providing customized drugs to a patient that may be performed by the drug dispenser device of FIGS. 1 and 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

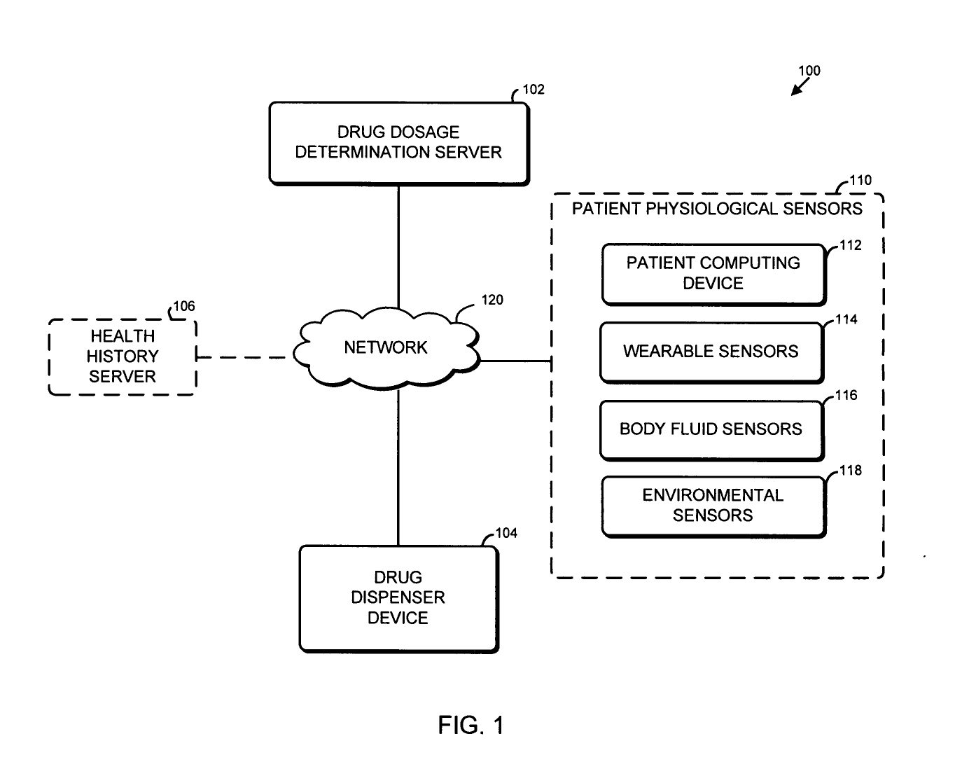

Referring now to FIG. 1, in an illustrative embodiment, a system 100 for providing customized drugs to patients includes a drug dosage determination server 102, a drug dispenser device 104, a health history server 106, and various patient physiological sensors 110, which may communicate with each other via a network 120. In use, as described in more detail herein, the drug dosage determination server 102 is configured to aggregate patient physiological data obtained from various patient physiological sensors 110 used by the patient and determine a drug dosage specialized for that particular patient based on the up-to-date patient's physiological data. The patient physiological sensors 110 are configured to monitor various characteristics of the patient's health, activities, and environment as discussed below. In some embodiments, the drug dosage determination server 102 may also consider the patient's health history and medical records (e.g., allergies, past reactions to drugs, etc.), which may be obtained from the health history server 106. Additionally, the drug dosage determination server 102 may aggregate physiological data from other patients, especially those prescribed with similar drugs, to facilitate the determination of the drug dosage for a particular patient. By analyzing physiological data from a larger pool of patients, health trends (e.g., adverse reactions) related to a particular drug, dosage level, environment, activities, and/or other factors may be identified.

Based on the aggregated physiological data, the drug dosage determination server 102 determines drug types, doses of the drugs, and treatment schedules for the patient. The up-to-date information obtained from such sources as the physiological sensors 110 and the health history server 106, allow the drug dosage determination server 102 to not only determine a drug dosage for individual patients based their age, weight, and/or other slowly changing physical characteristics, but also to adjust and update the drug dosages in response to quickly changing physiological data about the patient, other patients (e.g., unexpected adverse reactions), and their environments.

After the drug dosage determination server 102 has determines the drug dosage for a particular patient, the drug dosage determination server 102 is configured to generate and transmit drug dosage instructions to the drug dispenser device 104. As discussed in more detail below, the drug dosage instructions are usable by the drug dispenser device 104 to manufacture the drug at a dosage prescribed by the drug dosage instructions. Additionally, the drug dosage instructions dictate the treatment schedule for the patient, and the drug dispenser device 104 is configured to dispense the manufactured drugs according to the drug dosage instructions.

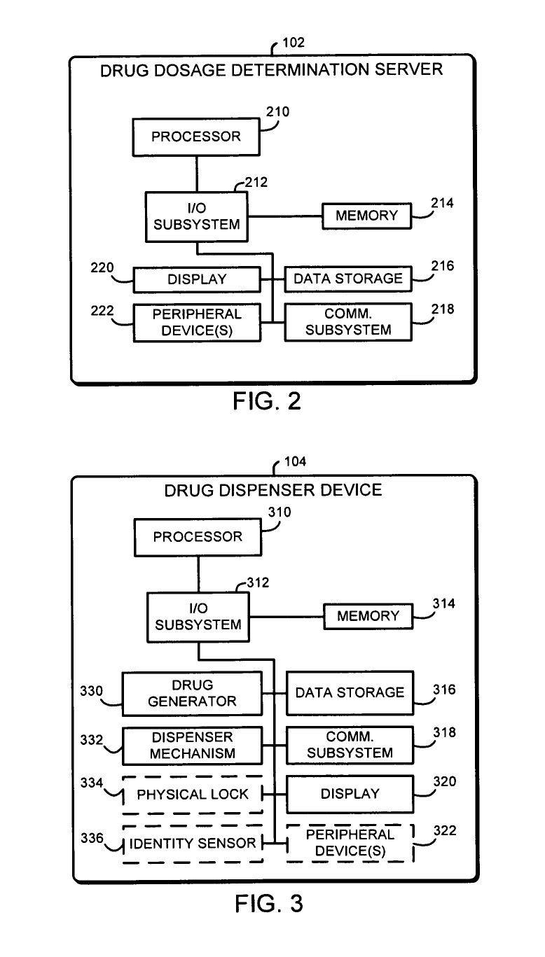

Referring now to FIG. 2, the drug dosage determination server 102 may be embodied as any type of device capable of determining a drug dosage for a patient based on patient physiological data, and otherwise performing the functions described herein. For example, the drug dosage determination server 102 may be embodied as, without limitation, a server computer, a distributed computing system, a networking device, a multiprocessor system, a consumer electronic device, a smart appliance, and/or any other computing device capable of performing the functions described herein. Although shown as a single computing device, it should be appreciated that the drug dosage determination server 102 may be embodied as a collection of servers and/or other compute devices configured to cooperate to perform the functions described herein.

The illustrative drug dosage determination server 102 includes a processor 210, an I/O subsystem 212, a memory 214, a data storage device 216, a communication subsystem 218, a display 220, and peripheral devices 212. Of course, the drug dosage determination server 102 may include other or additional components, such as those commonly found in a workstation (e.g., various input/output devices), in other embodiments. Additionally, in some embodiments, one or more of the illustrative components may be incorporated in, or otherwise form a portion of, another component. For example, the memory 214, or portions thereof, may be incorporated in the processor 210 in some embodiments.

The processor 210 may be embodied as any type of processor capable of performing the functions described herein. For example, the processor 210 may be embodied as a single or multi-core processor(s), digital signal processor, microcontroller, or other processor or processing/controlling circuit. Similarly, the memory 214 may be embodied as any type of volatile or non-volatile memory or data storage capable of performing the functions described herein. In operation, the memory 214 may store various data and software used during operation of the drug dosage determination server 102 such as operating systems, applications, programs, libraries, and drivers. The memory 214 is communicatively coupled to the processor 210 via the I/O subsystem 212, which may be embodied as circuitry and/or components to facilitate input/output operations with the processor 210, the memory 214, and other components of the drug dosage determination server 102. For example, the I/O subsystem 212 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 212 may form a portion of a system-on-a-chip (SoC) and be incorporated, along with the processor 210, the memory 214, and other components of the drug dosage determination server 102, on a single integrated circuit chip.

The data storage device 216 may be embodied as any type of device or devices configured for short-term or long-term storage of data such as, for example, memory devices and circuits, memory cards, hard disk drives, solid-state drives, or other data storage devices. The data storage device 216 may store, for example, received patient physiological data, health threat data, patient schedule data, health history data, and heuristics for determining drug dosages based on the afore-mentioned data.

The communication subsystem 218 may be embodied as any communication circuit, device, or collection thereof, capable of enabling communications between the drug dosage determination server 102 and other remote devices over a computer network (e.g., the network 120). The communication subsystem 218 may be configured to use any one or more communication technology (e.g., wired or wireless communications) and associated protocols (e.g., Ethernet, Bluetooth®, Wi-Fi®, WiMAX, etc.) to effect such communication.

Additionally, the drug dosage determination server 102 may include a display 150 that may be embodied as any type of display capable of displaying digital information such as a liquid crystal display (LCD), a light emitting diode (LED), a plasma display, a cathode ray tube (CRT), or other type of display device. In some embodiments, the drug dosage determination server 102 may also include one or more peripheral devices 212. The peripheral devices 212 may include any number of additional input/output devices, interface devices, and/or other peripheral devices.

Referring now to FIG. 3, the drug dispenser device 104 may be embodied as any manufacturing device capable of generating or manufacturing a drug based on drug dosage instructions received from the drug dosage determination server 102. For example, in the illustrative embodiment as discussed below, the drug dispenser device 104 is embodied as, or otherwise includes, a 3D printer capable of generating a drug. The drug dispenser device 104 may be configured for personal use and located in a patient's home or other private location or for public use and located as a pharmacy, hospital, or other public location.

In the illustrative embodiment, the drug dispenser device 104 includes a processor 310, an I/O subsystem 312, a memory 314, a data storage device 316, a communication subsystem 318, a display 320, and peripheral devices 322. Those components may be substantially similar to the corresponding components of the drug dosage determination server 102. As such, further descriptions of the like components are not repeated herein with the understanding that the description of the corresponding components provided above in regard to the source computing device 102 applies equally to the corresponding components of the destination computing device 106.

The illustrative drug dispenser device 104 also includes a drug generator 330 and a dispenser mechanism 332. Additionally, the drug dispenser device 104 may include a physical lock 334 and an identity sensor 336 in some embodiments. The drug generator 330 may be embodied as a physical component, such as an electromechanical component that is configured to fill capsules (e.g., pills) or other containers with one or more substances (including microbots), three dimensionally print (e.g., a 3D printer) doses of a drug from one or more substances, or otherwise generate doses of a drug in accordance with drug dosage instructions.

In the illustrative embodiment, the dispenser mechanism 332 may be embodied as any one or more devices capable of dispensing or providing access to the generated drug dose according to the drug dosage instructions. The dispenser mechanism may include an access component to allow patient access such as a door, slot, or similar components. The illustrative drug dispenser device 104 includes the physical lock 334, which may be embodied as a mechanical or electromechanical device that is configured to prevent access to drugs when the physical lock 334 is locked, and that is configured to allow access to the drugs through the dispenser mechanism 332 when the physical lock 334 is unlocked.

The illustrative drug dispenser device 104 also includes the identity sensor 336 which may be embodied as one or more components that are configured to receive or detect identifying information associated with a patient. For example, the identity sensor 336 may include or be embodied as biometric sensor, such as a camera configured for use in identifying a patient's face, eye, or other body part, an audio sensor configured to detect and identify a voice, or a fingerprint sensor. The identity sensor 336 may additionally or alternatively include a radio frequency identification sensor (RFID) and/or a keyboard, number pad, or other interface for receiving a username and/or password or other patient identification data. In other embodiments, the identity sensor 336 may be embodied as or include other components that are configured for use in identifying an individual. Although shown in FIG. 3 as a single device, it should be appreciated that the drug dosage determination server 102 may be embodied as multiple devices cooperating together to facilitate the functionality described below. Further, although shown separately, the drug dosage determination server 102 and the drug dispenser device 104 may be embodied in the same device, such as in embodiments in which the drug dosage determination server 102 and the drug dispenser device 104 are owned by the patient and are in the patient's home, rather than being used by members of the public (e.g., in pharmacies). Similarly, the health history server 106 may be embodied in the same device as the drug dosage determination server 102.

Referring back to FIG. 1, the health history server 106 may be embodied as any type of server computer capable of maintaining health history data related to the patients. The maintained health history data may include any type of health-related information associated with patients including, but not limited to, allergies, drug reactions, physiological characteristics, health concerns/issues, drug prescription history, and/or the like. The health history server 106 may include components commonly found in a server computer, such as a processor, memory, I/O subsystem, data storage, communication subsystem, etc. Those components may be substantially similar to the corresponding components of the drug dosage determination server 102. As such, further descriptions of the like components are not repeated herein with the understanding that the description of the corresponding components provided above in regard to the source computing device 102 applies equally to the corresponding components of the health history server 106.

The patient physiological sensors 110 may be embodied as, or otherwise include, any type of sensor capable of sensing, obtaining, and/or generating sensor data indicative of a physiological characteristic of the patient or from which a physiological characteristic may be derived. For example, the illustrative patient physiological sensors 110 may monitor physiological characteristics of the patient, activities of the patient, characteristics of the patient's environment, and/or other factors indicative of or which can impact the patient's physiological characteristics. The illustrative patient physiological sensors 110 include one or more patient computing devices 112, wearable sensors 114, body fluid sensors 116, and/or environmental sensors 118. Of course, the patient physiological sensors 110 may include additional or other types of sensors in other embodiments.

The patient computing device 112 may be embodied as any type of personal computing device such as a smartphone, tablet, or other computing device usable by a patient. In some embodiments, the patient computing device 112 may be embodied as a special-purpose computing device. In other embodiments, the patient computing device 112 may be a general-purpose device, such as the patient's personal smartphone.

The wearable sensors 114 may be embodied as any type of sensors capable of being worn by the patient and producing sensor data indicative of a physiological characteristic of the patient. For example, the wearable sensors 114 may include, but are not limited to, a heart rate sensor, a blood pressure sensor, a brain activity sensor (e.g., an electroencephalogram (EEG) sensor and/or a functional near-infrared spectroscopy (fNIRS) sensor), a temperature sensor, a pedometer, and/or other sensors configured to be worn by the patient and to measure physiological conditions of the patient.

The body fluid sensors 116 may be embodied as any type of sensor or sensing device capable of analyzing a body fluid of the user, such as waste fluids, saliva, or other substances from the patient's body to detect the presence of and/or amounts of medication, viruses, bacteria, sugar, or other items. For example, the body fluid sensors 116 may be embodied as a smart toilet or sink, a blood monitoring device, a smart saliva stick, and/or the like.

The environmental sensors 118 may be embodied as any type of sensors capable of measuring various environmental characteristics of the environment of the user. For example, the environmental sensors 188 may include sensors associated with the weather (e.g., temperature sensors and pressure sensors), as well as sensors configured to detect the presence of and/or measure the amount of bacteria, viruses, chemicals, and/or other substances that may affect the health of the patient.

In the illustrative embodiment, the patient computing device 112 may be to configured act as a communication link between the wearable sensors 114, the body fluid sensors 116, and/or the environmental sensors 118 and the drug dosage determination server 102. For example, the patient computing device 110 may receive patient physiological data from the other sensors 110 and transmit the patient physiological data to the drug dosage determination server 102. In alternative embodiments, one or more of the wearable sensors 114, the body fluid sensors 116, and/or the environmental sensors 118 may be configured to communicate directly with the drug dosage determination server 102. Though described above with reference to a single example patient, in the illustrative embodiment, the patient physiological sensors 110 are configured to generate patient physiological data for many patients, such that the drug dosage determination server 102 is able individually analyze patient physiological data to determine drug dosages for many patients as well as to aggregate the patient physiological data and detect trends.

A discussed above, the drug dosage determination server 102, the drug dispenser device 104, the patient physiological sensors 110, and the health history server 106 are each configured to communication over the network 120. The network 120 may be embodied as any number of various wired and/or wireless networks. For example, the network 120 may be embodied as, or otherwise include, a wired or wireless local area network (LAN), a wired or wireless wide area network (WAN), a cellular network, and/or a publicly-accessible, global network such as the Internet. As such, the network 120 may include any number of additional devices, such as additional computers, routers, and switches, to facilitate communications among the devices of the system 100.

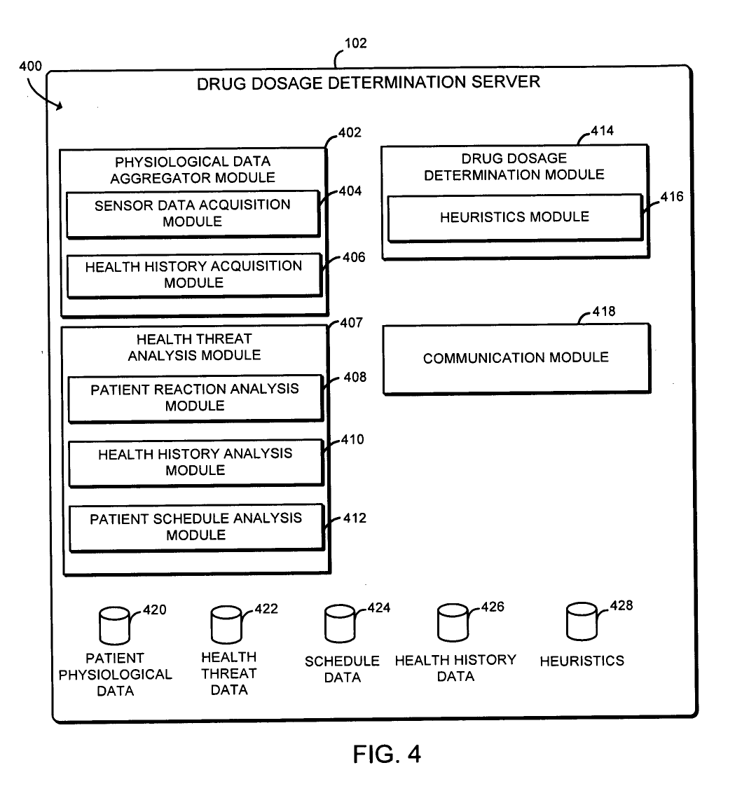

Referring now to FIG. 4, in the illustrative embodiment, the drug dosage determination server 102 establishes an environment 400 during operation. The illustrative environment 400 includes a physiological data aggregator module 402 that includes a sensor data acquisition module 404 and a health history acquisition module 406. Additionally, the environment 400 includes a health threat analysis module 407 that includes a patient reaction analysis module 408, a health history analysis module 410, and a patient schedule analysis module 412. Additionally, the environment 400 includes a drug dosage determination module 414 that includes a heuristics module 416. Further, the environment 400 includes a communication module 418. Each of the modules, logic, and other components of the environment 400 may be embodied as hardware, software, firmware, or a combination thereof. For example, each of the modules, logic, and other components of the environment 200 may form a portion of, or otherwise be established by, the processor 210, the memory 214, the communication circuitry 218, and/or other hardware components of the drug dosage determination server 102. As such, in some embodiments, one or more of the modules of the environment 400 may be embodied as circuitry or a collection of electrical devices (e.g., a physiological data aggregator circuit 402, a health threat analysis circuit 407, a drug dosage determination module 414, a communication circuit 418, etc.).

The physiological data aggregator module 402 is configured to aggregate physiological data 420 from multiple sources including the patient physiological sensors 110 and the health history server 106, pertaining to multiple patients. In the illustrative embodiment, the sensor data acquisition module 404 is configured to acquire sensor data (e.g., patient physiological data 420 transmitted from patient physiological sensors 110). The health history acquisition module 406 is configured to acquire health history data 426 for use by the physiological data aggregator module 402. In acquiring data, such as the patient physiological data 420 and the health history data 426, the respective modules 404 and 406 may poll the sources for the data, receive the data as it is pushed to the modules 404 and 406, and/or store and retrieve the data from respective databases.

The health threat analysis module 407 is configured to identify threats to a patient based on one or more sources of data, including current physiological conditions of a patient, allergies or other adverse reactions to drugs in an individual patient's health history, and/or a patient's scheduled travel to a location where a disease or other health threat has emerged. In the illustrative embodiment, the patient reaction analysis module 408 is configured to identify whether the patient is currently experiencing a physiological condition that would be exasperated or otherwise lead to a health threat in response to a dosage of a drug, or conversely, in response to the lack of a drug. For example, the patient may be experiencing elevated blood pressure and a particular dosage of a drug that would normally be dispensed to the patient would further increase the patient's blood pressure to dangerous levels. As another example, the patient reaction analysis module 408 may determine that the patient is exhibiting flu-like symptoms, such as an elevated temperature, and the lack of a fever-reducing drug may lead to a dangerously high body temperature. Further, the patient reaction analysis module 408 may detect a trend in the aggregated physiological data associated with multiple patients indicating that the multiple patients are experiencing an unforeseen side effect of a dosage of a drug, that the patients are experiencing adverse reactions to environmental conditions associated with a location, or that the patients are suffering from an outbreak of a disease or other illness. The health history analysis module 410 is configured to analyze the health history data 426 and determine whether a particular dosage of a drug would be hazardous to the patient. For example, the health history analysis module 410 may determine that the patient has previously experienced an allergic reaction to a drug that would otherwise be prescribed in view of the physiological data from the patient physiological sensors 110. In the illustrative embodiment, the patient schedule analysis module 412 is configured to analyze schedule data 424 associated with the patient to identify health threats. For example, the patient schedule analysis module 412 may identify, in the patient's schedule data 424, a scheduled trip to a particular location on a particular date. The patient schedule analysis module 412 may then correlate the scheduled location and date with a disease or illness outbreak at that location (i.e., as may be determined by the patient reaction analysis module 408), and determine that the patient will be exposed to the health threat on the scheduled date. As discussed in more detail herein, the drug dosage determination server 102 may adjust or update a drug dosage in response to detecting a health threat, so as to eliminate or minimize the health threat for the patient.

The drug dosage determination module 414 is configured to determine a drug dosage for a patient based on the patient physiological data 420, the health threat data 422, the schedule data 424, the health history data 426, and heuristics 428. The drug dosage determination module 414 is configured to determine the type of drug to be prescribed, the dosage amount of the prescribed drug, and the treatment schedule for the prescribed drug based on the patient's own physiological data 420, aggregated patient physiological data 420 from multiple patients, the patient's health history data 426, and/or the patient's schedule data 424. In the illustrative embodiment, the heuristics module 416 applies the data to heuristics 428 that define rules for the drug type, the amount of the drug in each dose, and the treatment schedule, based on the above data. The drug dosage determination module 414 is also configured to generate drug dosage instructions to be transmitted to a drug dispenser device 104. In the illustrative embodiment, the drug dosage instructions are configured to be executed by the drug dispenser device 104 to generate and dispense drug doses in accordance with the determined drug dosage. In the illustrative embodiment, the drug dosage determination module 414 adds authentication information (e.g., patient identity and other authentication credentials) for the patient to the drug dosage instructions to enable the drug dispensing device 104 to dispense the drugs to the correct patients.

The communication module 418 is configured to receive data from devices, such as the patient physiological sensors 110, the health history server 106, and the drug dispenser device 104. Further, the communication module 418 is configured to transmit data to devices, such as requests for the patient physiological data 420 and/or the health history data 426.

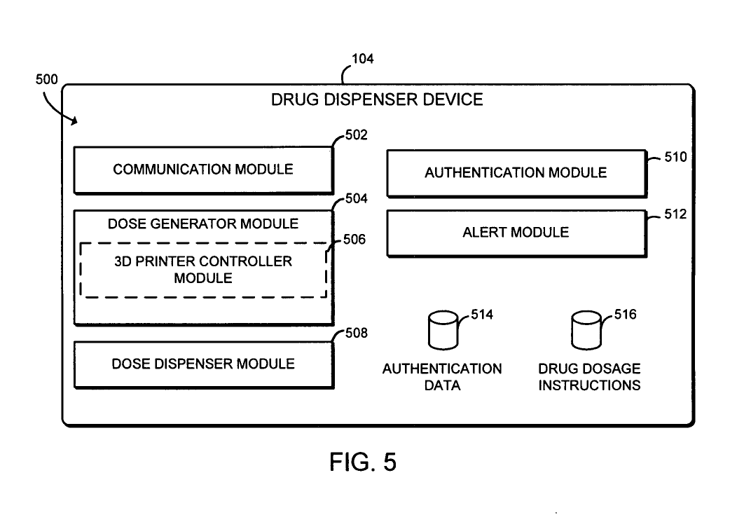

Referring now to FIG. 5, in the illustrative embodiment, the drug dispenser device 104 establishes an environment 500 during operation. The illustrative environment 500 includes a communication module 502, a dose generator module 504, a dose dispenser module 508, an authentication module 510, and an alert module 512. Each of the modules, logic, and other components of the environment 500 may be embodied as hardware, software, firmware, or a combination thereof. For example, each of the modules, logic, and other components of the environment 500 may form a portion of, or otherwise be established by, the processor 310, the memory 314, the communication circuitry 318, and/or other hardware components of the drug dispenser device 104. As such, in some embodiments, one or more of the modules of the environment 400 may be embodied as circuitry or a collection of electrical devices (e.g., a communication circuit 502, a dose generator circuit 504, a dose dispenser circuit 508, an authentication circuit 510, and an alert circuit 512 etc.).

The communication module 502 is configured to facilitate communications between the drug dispenser device 104 and the drug dosage determination server 102 and/or other devices of the system 100. In the illustrative embodiment, the communication module 502 receives drug dosage instructions 516 from one or more drug dosage determination servers 102. Further, the communication module 502 may transmit responses, such as acknowledgements that the drug dosages instructions 516 have been received and/or that the associated drugs were successfully generated and/or dispensed. Further, the communication module 502 may transmit alert messages to one or more devices indicating that the drug dispenser device 104 has been tampered with.

The dose generator module 504 is configured to generate doses of drugs in accordance with the drug dosage instructions 516. In the illustrative embodiment, the dose generator module 504 may execute the drug dosage instructions 516 to control the types and amounts of substances that are included in a dose of a drug. In some embodiments, the substances may include, but are not limited to fluids, solids, organic material, inorganic material, vitamins, and/or microbots. In the illustrative embodiment, the dose generator module 504 includes a 3D printer controller module 506 which is configured to control a 3D printer (e.g., drug generator 330 in FIG. 3) to print specified amounts of substances into a pill or other form to create a dose of the drug.

The dose dispenser module 508 is configured to control the dispenser mechanism 332 to dispense doses of drugs to patients after the drug doses have been generated. In the illustrative embodiment, the dose dispenser module 508 is configured to dispense doses of the drugs in accordance with a treatment schedule indicated by the drug dosage instructions 516. For example, the drug dosage instructions 516 may indicate that a particular drug is to be dispensed twice a day, in the morning and at night. Accordingly, the dose dispenser module 508 may be configured to dispense one dose in the morning and one dose at night to the corresponding patient. In the illustrative embodiment, the dose dispensing module 508 dispenses no more than the prescribed dose for the particular time in the treatment schedule, given that the drug dosage instructions may change before the next dosage is to be consumed by the patient, and to prevent the patient from consuming doses earlier than the treatment schedule calls for.

The authentication module 510 is configured to control access to drugs such that only patients who successfully authenticate to the drug dispenser device 104 will receive their prescribed drug doses. In the illustrative embodiment, the authentication module 510 may acquire patient identification data (e.g., the authentication data 514), for example from the drug dosage instructions 516, prompt the patient for authentication credentials, receive authentication credentials from the patient, and compare the patient identification data to the received authentication credentials to determine whether the patient is authenticated. In the illustrative embodiment, the authentication module 510 is further configured to lock the drug dispenser device 104 prior to determining whether the patient is authenticated and to unlock the dispenser device 104 after the patient is authenticated. Moreover, in the illustrative embodiment, the authentication module 510 is configured to determine, from the patient identification data, whether the patient is less than 18 years old, or some other specified age threshold, and if so, require a parent of the patient to enter authentication credentials in order for the authentication to be successful. The authentication module 510 may be configured to receive the authentication credentials in various forms, such as biometric data, RFID data, a personal identification number (PIN), and/or a username and password combination.

The alert module 512 is configured to generate an alert in response to certain occurrences. For example, in the illustrative embodiment, the alert module 512 may generate an alert in response to a determination that the drug dosage instructions 516 have been changed due to a health threat. More specifically, in the illustrative embodiment, the received drug dosage instructions 516 may include an indicator that the drug dosage instructions 516 were revised due to the detection of a health threat, as described with reference to FIG. 4. Further, in the illustrative embodiment, the alert module 512 is also configured to generate an alert in response to detecting that the drug dispenser device 104 has been tampered with. For example, the alert module 512 may receive an error message from the dose dispenser module that the physical lock 334 is inoperative. The alerts may be visual alerts displayed by display 220, audible alerts, and/or alert messages transmitted to one or more other devices through the network 120.

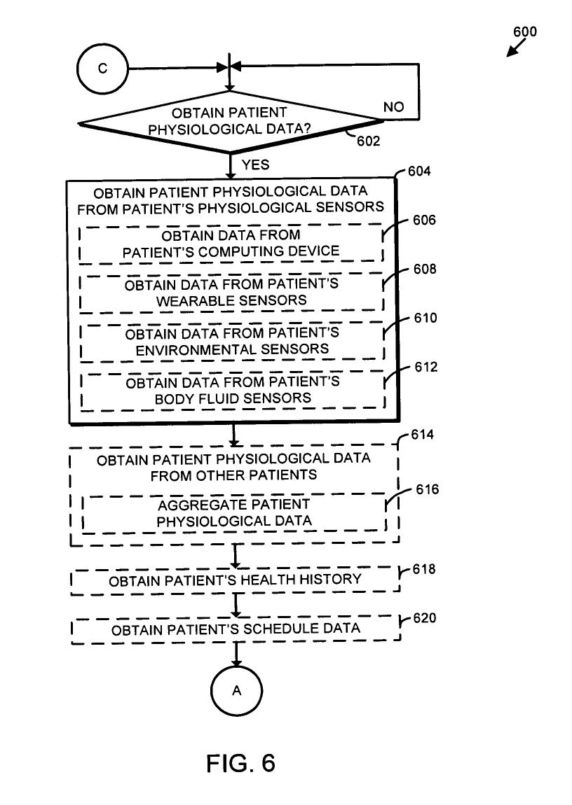

Referring now to FIGS. 6-8, in use, the drug dosage determination server 102 may execute a method 600 for determining a drug dosage for a patient. The method 600 begins with block 602, in which the drug dosage determination server 102 determines whether to obtain the patient physiological data 420. In the illustrative embodiment, the drug dosage determination server 102 may execute a process that polls the physiological sensors 110 for the patient physiological data 420. In other embodiments, the patient physiological sensors 110 may be configured to push the patient physiological data 420 to the drug dosage determination server 102. Regardless, when the drug dosage determination server 102 determines to obtain the patient physiological data 109, the method 600 advances to block 604.

In block 604, the drug dosage determination server 102 obtains the patient physiological data 420 from the patient's physiological sensors 110. For example, in the illustrative embodiment in block 606, the drug dosage determination server 102 may obtain at least a portion of the patient physiological data 420 from the patient computing device 112. For example, the patient computing device 112 may receive patient physiological data 420 from the wearable sensors 114, the body fluid sensors 116, and/or the environmental sensors 118 and transmit the patient physiological data 420 to the drug dosage determination server 102 on behalf of the sensors 109. In other embodiments, the patient physiological sensors 110 transmit the patient physiological data 420 directly to the drug dosage determination server 102. Regardless, in block 608, in the illustrative embodiment, the drug dosage determination server 102 may obtain patient physiological data from the wearable sensors 114, such as data from a heart rate sensor, a blood pressure sensor, a brain activity sensor (e.g., an electroencephalogram (EEG) sensor and/or a functional near-infrared spectroscopy (fNIRS) sensor), and/or a pedometer. In block 610, the drug dosage determination device 102 may obtain data from the environmental sensors 118 associated with the patient's environment. For example, the drug dosage determination server 102 may obtain data associated with the weather (e.g., from temperature sensors and/or pressure sensors) in the vicinity of the patient, as well as data indicating the presence of and/or the amount of bacteria, viruses, chemicals, and/or other substances that may affect the health of the patient. In the illustrative embodiment, in block 612, the drug dosage determination device 102 may obtain patient physiological data 420 from the body fluid sensors 116 that have generated data regarding the patient. For example, the drug dosage determination device 102 may receive data indicating the presence of and/or amounts of medication, viruses, bacteria, sugar, or other substances in the patient's body fluids.

After the drug dosage determination server 102 obtains the physiological data 420 from the patient's physiological sensors 110, the method 600 advances to block 614, in which the drug dosage determination server 102 may obtain patient physiological data 420 associated with other patients. For example, other patients may also be wearing wearable sensors 110, having their body fluids analyzed by body fluid sensors 116, and/or be in areas with environmental sensors 118 that report patient physiological data 420 back to the drug dosage determination server 102 for analysis. In the illustrative embodiment, as indicated in block 616, the drug dosage determination server 616 aggregates the patient physiological data 420 obtained from the various patients. Aggregating the patient physiological data 420 associated with multiple patients enables the drug dosage determination server 102 to identify emerging trends, such as disease outbreaks in various locations and effects of drugs consumed by the patients. The method 600 then advances to block 618.

In block 618, the drug dosage determination server 102 ma also obtain the patient's health history data 426. In the illustrative embodiment, the drug dosage determination server 102 obtains the health history data 426 from the health history server 106. In some embodiments, the drug dosage determination server 102 polls the health history server 106 for the data, for example by transmitting a query for the data, and receives the data in response to the query. In other embodiments, the drug dosage determination server 102 receives the health history data 426 from the health history server 106 asynchronously. The health history data 426 may indicate allergies, adverse reactions to certain drugs, or other medical record data that may bear on the determination of a drug dosage for the patient.

In block 620, the drug dosage determination server 102 obtains the patient's schedule data 424. The illustrative drug dosage determination server 102 may request the schedule data 424 from the patient computing device 112 and receive the schedule data 424 in response to the request. In other embodiments, the drug dosage determination server 102 obtains the schedule data 424 from another server (not shown). The schedule data 424 may indicate that the patient is scheduled to travel to a particular location on a particular date, in which case the patient may be exposed to a disease outbreak or other factors that could impact the patient's health. The schedule data 424 may also indicate scheduled exercise or other activities that could affect the patient's physiological conditions (e.g., increased pulse, increased blood pressure, etc.).

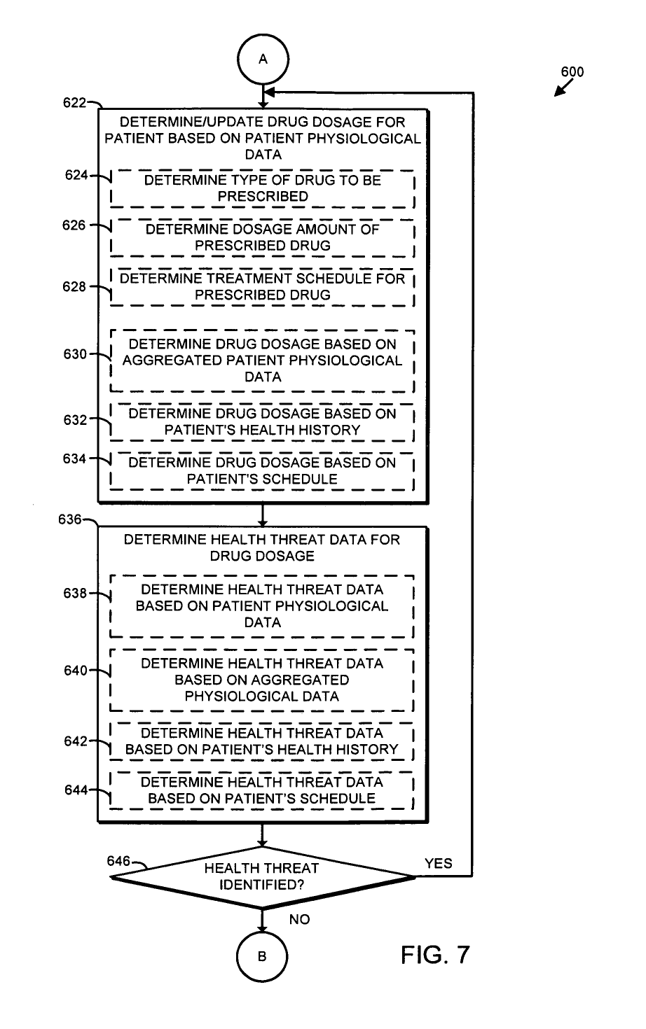

After drug dosage determination server 102 obtains the patient's schedule data 424, the method 600 advances to bock 622 of FIG. 7. In block 622, the drug dosage determination server 102 determines a drug dosage for the patient based on the received data. To do so, in the illustrative embodiment, the drug dosage determination server 102 may apply the received data to the heuristics 428 to determine the type of drug to be prescribed in block 624, the dosage amount of the prescribed drug in block 626, and a treatment schedule for the prescribed drug (e.g., once in the morning and once at night) in block 628. Further, as indicated in block 630, the illustrative drug dosage determination server 102 may determine the drug dosage based on the aggregated patient physiological data 420. For example, the drug dosage determination server 102 may determine that a particular dosage of a particular drug is effective at reducing blood pressure, based on the aggregated patient physiological data 420 of a group of patients who consumed doses of the drug and who experienced decreased blood pressure. Additionally, in some embodiments in block 632, the illustrative drug dosage determination server 102 may determine the drug dosage based on the patient's health history. For example, the drug dosage determination server 102 may adjust the dosage of the drug based on the weight and/or age of the patient. Further, in some embodiments in block 634, the illustrative drug dosage determination server 102 may determine the drug dosage based on the patient's schedule (e.g., schedule data 424). For example, the drug dosage determination server 102 may adjust the dosage to include a particular amount of a particular drug that will boost the patient's immune system against illness in a relatively cold environment or that will reduce exhaustion during a scheduled sports activity.

Subsequently, in block 636, the drug dosage determination server 102 determines any health threat data 422 that is pertinent to the drug dosage to be prescribed to the patient. For example, in block 638, the drug dosage determination server 102 may determine the health threat data 422 based on the patient physiological data 420 received from the physiological sensors 110 associated with the patient. For example, the drug dosage determination server 102 may determine that the patient is experiencing high anxiety, as indicated by the pulse and/or brain activity, and that a dose of a drug that would otherwise be consumed by the patient would be a health risk in view of the patient's present physiological conditions. That is, the dose of the drug may increase the patient's pulse to a dangerous level.

Additionally, in block 640, the illustrative drug dosage determination server 102 may determine the health threat data 422 based on aggregated physiological data. For example, the drug dosage determination server 102 may determine that other patients in the geographic area of the patient are exhibiting flu-like symptoms, such as increased body temperatures and the presence of increased mucus and/or virus material in their body fluids. Further, in block 642, the illustrative drug dosage determination server 102 may determine the health threat data 422 based on the patient's health history data 426. For example, the drug dosage determination server 102 may determine that the patient is allergic to a particular drug that would otherwise be prescribed to the patient in view of the physiological data 420 received from the patient physiological sensors 110. Additionally, in block 644, the illustrative drug dosage determination server 102 may determine the health threat data 422 based on the patient's schedule data 424. For example, the patient may be scheduled to travel to another country where a disease outbreak has occurred. In the example, the patient's immune system may be better prepared to resist the disease if the patient consumes a particular drug dosage.

After the drug dosage determination server 102 has determined any associated health threat data in block 636, the method 600 advances to block 646. In block 646, the illustrative drug dosage determination server 102 determines whether a pertinent health threat has been identified from block 636. If so, the method 600 loops back to block 622 in which the drug dosage determination server 102 adjusts the drug dosage to account for the identified health threat. In this way, the drug dosage determination server 102 may monitor and adjust the drug dosage based on identified heath threats prior to prescribing the drug. Of course, it should be appreciated that the drug dosage determination server 102 may execute blocks 622, 636 periodically or continually to monitor for trending health threats and adjust a patient's previously determined prescription response to an identified health threat and/or preemptively.

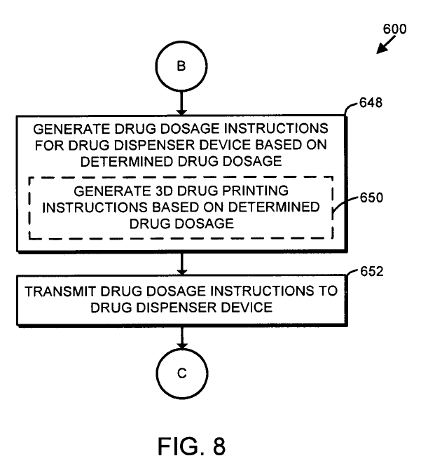

If a health threat is not identified at block 646, the method 600 advances to block 648 of FIG. 8. In block 648, the drug dosage determination server 102 generates drug dosage instructions 516 for the drug dispenser device 104, based on the determined drug dosage from block 622. The drug dosage instructions 516 are usable (e.g., as executable instructions) by the drug dispenser device 102 to control the generation of drug doses and the dispensing of the drug doses. In the illustrative embodiment, the drug dosage instructions include the types of drugs, the amounts of each drug, and treatment schedules (i.e., when to dispense the drugs). Additionally, in the illustrative embodiment, the drug dosage determination server 102 also includes, in the drug dosage instructions 516, authentication data (e.g., authentication data 514) associated with the patient who is to receive the drug dosage and an indicator of whether the drug dosage instructions have been updated due to a health threat.

As discussed above, in the illustrative embodiment, the drug dispenser device 102 includes, or otherwise is embodied as, a 3D printer. As such, in the illustrative embodiment in block 650, the drug dosage determination server 102 may generate 3D drug printing instructions based on the determined drug dosage. Accordingly, in such embodiments, the 3D drug printing instructions are configured to be executed by the drug dispenser device 102 to print the drug into a pill or other form. Regardless, after the drug dosage instructions have been generated, the method 600 advances to block 652 in which the drug dosage determination server 102 transmits the drug dosage instructions 516 to the drug dispenser device 652. The method 600 may subsequently loop back to block 602 of FIG. 6 in which the drug dosage determination server 102 obtains additional patient physiological data.

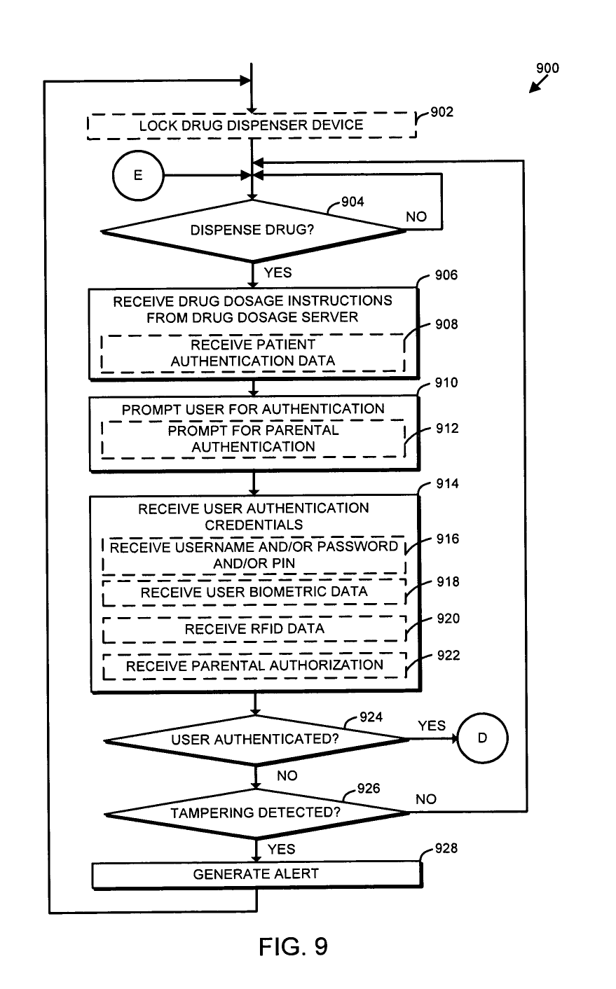

Referring now to FIG. 9, in use, the drug dispenser device 104 may execute a method 900 for providing customized drugs to the patient. The method 900 begins with block 902 in which the drug dispenser device 902 may lock itself, if it is not already locked, to prevent unauthorized access to any drug or drug component. In block 904, the drug dispenser device 104 determines whether to dispense a drug 904. For example, the drug dispenser device 104 may determine, after a diagnostic process, that it is capable of generating and dispensing drugs in accordance with any drug dosage instructions. In block 906, the drug dosage determination device 104 receives the drug dosage instructions 516 from the drug dosage determination server 102. In the illustrative embodiment, as indicated in block 908, the drug dispenser device 104 also receives patient authentication data 908, which may identify the patient and include criteria for authenticating the patient.

Subsequently, in block 910, the drug dispenser device 104 prompts a user of the drug dispenser device 104 for authentication. For example, as indicated in block 912, the drug dispenser device 104 may prompt for parental authentication, such as upon determining from the patient authentication data that the patient does not satisfy a threshold age (e.g., 18 years old). In block 914, the drug dispenser device 104 receives user authentication credentials in response to the prompt provided in block 910. Depending on the embodiment, the drug dispenser device 104 may receive the authentication credentials in a variety of ways. For example, as indicated in block 916, the drug dispenser device 104 may receive a username, password, and/or PIN. Additionally or alternatively, in block 918, the drug dispenser device 104 may receive user biometric data 918, such as an image of the user, fingerprint data, or voice data. Additionally or alternatively, in block 920, the drug dispenser device 104 may receive the authentication credentials from an RFID tag associated with the user. Further, in some embodiments in block 922, the drug dispenser device 104 may receive authorization and/or authentication credentials from a parent of the user such as when the user does not satisfy the threshold age (e.g., 18 years old).

Subsequently, in block 924, the drug dispenser device 104 determines whether the user is authenticated. To do so, in the illustrative embodiment, the drug dispenser device 104 compares the received authentication credentials, and if applicable, the parental authorization, to the authentication data 514 to determine whether the authentication credentials satisfy the authentication data 514. If the user is not authenticated in block 924, the method 900 advances to block 926 in which the drug dispenser device 104 determines whether the drug dispenser device 104 is being or has been tampered with. As an example, the drug dispenser device 104 may detect an error signal from the dispenser mechanism 332 indicating that it has been forced open. If the drug dispenser device 104 does not detect tampering, then the method 900 returns to block 904 in which the drug dispenser device 104 again determines whether to dispense a drug. However, if the drug dispenser device 104 detects tampering, the method 900 advances to block 928. In block 928, the drug dispenser device 104 generates an alert indicating that the drug dispenser device 104 has been tampered with. The alert may be a visual alert that may be displayed by display 220, an audible alert, or an alert message transmitted to another device communicatively coupled with the drug dispenser device 104. The method 900 subsequently returns to block 902 to lock the drug dispenser device 104, if not presently locked.

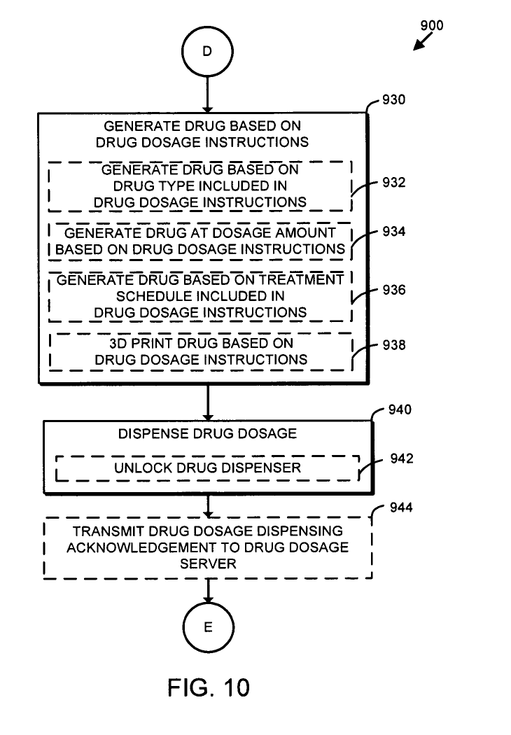

Referring back to block 924, if the drug dispenser device 104 determines that the use is authenticated, the method 900 advances to block 930 of FIG. 10. In block 930, the drug dispenser device 104 generates the drug based on the drug dosage instructions 516. For example, as indicated in block 932, the illustrative drug dispenser device 104 may generate the drug based on the drug type included in the drug dosage instructions 516. Additionally, as indicated block 934, the drug dispenser device 104 may generate the drug at a dosage amount based on the drug dosage instructions 934. Further, as indicated in block 936, the drug dispenser device 104 may generate the drug based on the treatment schedule included in the drug dosage instructions 516. As discussed above, the drug dispenser device 104 may generate the drug dose in any suitable manner. For example in the illustrative embodiment in block 938, the drug dispenser device 104 three dimensionally prints the drug based on the drug dosage instructions 516.

After the drug dispenser device 104 has generated the drug in block 930, the method 900 advances to block 940 in which the drug dispenser device 940 dispenses the drug dosage to the authenticated user (i.e., the patient). In the illustrative embodiment, in dispensing the drug dosage, the drug dispenser device 104 unlocks itself, as indicated in block 942. In some embodiments, in block 944, the drug dispenser device 104 may also transmit a drug dosage dispensing acknowledgement to the drug dosage server 944 after dispensing the drug dosage to the patient. The method 900 subsequently loops back to block 904 in which the drug dispenser device 104 again determines whether to dispense a drug.

### EXAMPLES

Illustrative examples of the technologies disclosed herein are provided below. An embodiment of the technologies may include any one or more, and any combination of, the examples described below.

Example 1 includes a drug dosage determination server for determining a drug dosage for a patient, the drug dosage determination server comprising a physiological data aggregator module to obtain patient physiological data from physiological sensors associated with the patient; a drug dosage determination module to determine a drug dosage for the patient based on the obtained patient physiological data and to generate drug dosage instructions for a drug dispenser device, based on the determined drug dosage, wherein the drug dosage instructions are usable by the drug dispenser device to generate a drug; and a communication module to transmit the drug dosage instructions to the drug dispenser device.

Example 2 includes the subject matter of Example 1, and wherein the physiological sensors comprise a patient computing device.

Example 3 includes the subject matter of any of Examples 1 and 2, and wherein the physiological sensors comprise at least one wearable sensor associated with the patient.

Example 4 includes the subject matter of any of Examples 1-3, and wherein the physiological sensors comprise at least one environmental sensor associated with the patient.

Example 5 includes the subject matter of any of Examples 1-4, and wherein the physiological sensors comprise at least one body fluid sensor associated with the patient.

Example 6 includes the subject matter of any of Examples 1-5, and wherein the patient is one of a plurality of patients, and the physiological data aggregator module is further to obtain patient physiological data associated with the plurality of patients and aggregate the obtained patient physiological data to produce aggregated physiological data, and wherein to determine the drug dosage for the patient comprises to determine a drug dosage based on the aggregated physiological data.

Example 7 includes the subject matter of any of Examples 1-6, and wherein the drug dosage determination module is further to determine at least one of a type of drug to be prescribed, a dosage amount of the drug to be prescribed, and a treatment schedule for the drug to be prescribed based additionally on the aggregated patient physiological data and at least one predefined heuristic.

Example 8 includes the subject matter of any of Examples 1-7, and wherein the physiological data aggregator module is further to obtain health history data associated with the patient, and wherein to determine the drug dosage for the patient comprises to determine a drug dosage based on the obtained physiological data and the health history data.

Example 9 includes the subject matter of any of Examples 1-8, and wherein the drug dosage determination module is further to determine at least one of a type of drug to be prescribed, a dosage amount of the drug to be prescribed, and a treatment schedule for the drug to be prescribed based additionally on the obtained health history data associated with the patient and at least one predefined heuristic.

Example 10 includes the subject matter of any of Examples 1-9, and wherein the physiological data aggregator module is further to obtain schedule data associated with the patient, and wherein to determine the drug dosage for the patient comprises to determine a drug dosage based on the obtained physiological data and the schedule data.

Example 11 includes the subject matter of any of Examples 1-10, and wherein the drug dosage determination module is further to determine at least one of a type of drug to be prescribed, a dosage amount of the drug to be prescribed, and a treatment schedule for the drug to be prescribed, based additionally on the schedule data associated with the patient and at least one predefined heuristic.

Example 12 includes the subject matter of any of Examples 1-11, and wherein to determine the drug dosage for the patient comprises to determine a drug type for the patient based on the obtained patient physiological data and at least one predefined heuristic.

Example 13 includes the subject matter of any of Examples 1-12, and wherein to determine the drug dosage for the patient comprises to determine a dosage amount for the patient based on the obtained patient physiological data and at least one predefined heuristic.

Example 14 includes the subject matter of any of Examples 1-13, and wherein to determine the drug dosage for the patient comprises to determine a treatment schedule for the patient based on the obtained patient physiological data and at least one predefined heuristic.

Example 15 includes the subject matter of any of Examples 1-14, and, further including a health threat analysis module to determine health threat data for the drug dosage; and wherein the drug dosage determination module is further to adjust the drug dosage instructions based on the health threat data.

Example 16 includes the subject matter of any of Examples 1-15, and wherein the health threat analysis module is further to identify a health threat based on the patient physiological data.

Example 17 includes the subject matter of any of Examples 1-16, and wherein the patient is one of a plurality of patients, and wherein the health threat analysis module is further to identify a health threat based on aggregated physiological data associated with the plurality of patients.

Example 18 includes the subject matter of any of Examples 1-17, and wherein the health threat analysis module is further to identify a health threat based on health history data associated with the patient.

Example 19 includes the subject matter of any of Examples 1-18, and wherein the health threat analysis module is further to identify a health threat based on schedule data associated with the patient.

Example 20 includes the subject matter of any of Examples 1-19, and wherein the drug dosage instructions comprises three dimensional drug printing instructions usable by a three dimensional printer to generate the drug.

Example 21 includes a method for determining a drug dosage for a patient, the method comprising obtaining, by a drug dosage determination server, patient physiological data from physiological sensors associated with the patient; determining, by the drug dosage determination server, the drug dosage for the patient based on the obtained patient physiological data; generating, by the drug dosage determination server, drug dosage instructions for a drug dispenser device, based on the determined drug dosage, wherein the drug dosage instructions are usable by the drug dispenser device to generate a drug; and transmitting, by the drug dosage determination server, the drug dosage instructions to the drug dispenser device.

Example 22 includes the subject matter of Examples 21, and wherein obtaining the patient physiological data comprises obtaining the patient physiological data from a patient computing device.

Example 23 includes the subject matter of any of Examples 21 and 22, and wherein obtaining the patient physiological data comprises obtaining the patient physiological data from at least one wearable sensor associated with the patient.

Example 24 includes the subject matter of any of Examples 21-23, and wherein obtaining the patient physiological data comprises obtaining the patient physiological data from at least one environmental sensor associated with the patient.

Example 25 includes the subject matter of any of Examples 21-24, and wherein obtaining the patient physiological data comprises obtaining the patient physiological data from at least one body fluid sensor associated with the patient.

Example 26 includes the subject matter of any of Examples 21-25, and wherein the patient is one of a plurality of patients, the method further comprising obtaining, by the drug dosage determination server, the patient physiological data from physiological sensors associated with the plurality of patients; and aggregating, by the drug dosage determination server, the obtained patient physiological data to produce aggregated physiological data, and wherein determining the drug dosage for the patient comprises determining the drug dosage based on the aggregated physiological data.

Example 27 includes the subject matter of any of Examples 21-26, and further including determining, by the drug dosage determination server, at least one of a type of drug to be prescribed, a dosage amount of the drug to be prescribed, and a treatment schedule for the drug to be prescribed, based additionally on the aggregated patient physiological data and at least one predefined heuristic.

Example 28 includes the subject matter of any of Examples 21-27, and further including obtaining, by the drug dosage determination server, health history data associated with the patient, and wherein determining the drug dosage for the patient comprises determining a drug dosage based on the obtained physiological data and the health history data.

Example 29 includes the subject matter of any of Examples 21-28, and further including determining, by the drug dosage determination server, at least one of a type of drug to be prescribed, a dosage amount of the drug to be prescribed, and a treatment schedule for the drug to be prescribed, based additionally on the obtained health history data associated with the patient and at least one predefined heuristic.

Example 30 includes the subject matter of any of Examples 21-29, and further including obtaining, by the drug dosage determination server, schedule data associated with the patient, and wherein determining the drug dosage for the patient comprises determining a drug dosage based on the obtained physiological data and the schedule data.

Example 31 includes the subject matter of any of Examples 21-30, and further including determining, by the drug dosage determination server, at least one of a type of drug to be prescribed, a dosage amount of the drug to be prescribed, and a treatment schedule for the drug to be prescribed, based additionally on the schedule data associated with the patient and at least one predefined heuristic.

Example 32 includes the subject matter of any of Examples 21-31, and wherein determining the drug dosage for the patient comprises determining a type of drug to be prescribed to the patient, based on the obtained patient physiological data and at least one predefined heuristic.

Example 33 includes the subject matter of any of Examples 21-32, and wherein determining the drug dosage for the patient comprises determining a dosage amount of a drug to be prescribed to the patient, based on the obtained patient physiological data and at least one predefined heuristic.

Example 34 includes the subject matter of any of Examples 21-33, and wherein determining the drug dosage for the patient comprises determining a treatment schedule associated with a drug to be prescribed to the patient, based on the obtained patient physiological data and at least one predefined heuristic.

Example 35 includes the subject matter of any of Examples 21-34, and further including determining, by the drug dosage determination server, health threat data for the drug dosage; and adjusting, by the drug dosage determination server, the drug dosage instructions based on the health threat data.

Example 36 includes the subject matter of any of Examples 21-35, and further including identifying, by the drug dosage determination server, a health threat based on the patient physiological data.

Example 37 includes the subject matter of any of Examples 21-36, and wherein the patient is one of a plurality of patients, the method further comprising identifying, by the drug dosage determination server, a health threat based on aggregated physiological data associated with the plurality of patients.

Example 38 includes the subject matter of any of Examples 21-37, and further including identifying, by the drug dosage determination server, a health threat based on health history data associated with the patient.

Example 39 includes the subject matter of any of Examples 21-38, and further including identifying, by the drug dosage determination server, a health threat based on schedule data associated with the patient.

Example 40 includes the subject matter of any of Examples 21-39, and wherein generating the drug dosage instructions further comprises generating three dimensional drug printing instructions usable by a three dimensional printer to generate the drug.

Example 41 includes one or more computer-readable storage media comprising a plurality of instructions that, when executed, cause a drug dosage determination server to perform the method of any of Examples 21-40.

Example 42 includes a drug dosage determination server for determining a drug dosage for a patient, the drug dosage determination server comprising means for obtaining patient physiological data from physiological sensors associated with the patient; means for determining the drug dosage for the patient based on the obtained patient physiological data; means for generating drug dosage instructions for a drug dispenser device, based on the determined drug dosage, wherein the drug dosage instructions are usable by the drug dispenser device to generate a drug; and means for transmitting the drug dosage instructions to the drug dispenser device.

Example 43 includes the subject matter of Example 42, and wherein the means for obtaining the patient physiological data comprises means for obtaining the patient physiological data from a patient computing device.

Example 44 includes the subject matter of any of Examples 42 and 43, and wherein the means for obtaining the patient physiological data comprises means for obtaining the patient physiological data from at least one wearable sensor associated with the patient.

Example 45 includes the subject matter of any of Examples 42-44, and wherein the means for obtaining the patient physiological data comprises means for obtaining the patient physiological data from at least one environmental sensor associated with the patient.

Example 46 includes the subject matter of any of Examples 42-45, and wherein the means for obtaining the patient physiological data comprises means for obtaining the patient physiological data from at least one body fluid sensor associated with the patient.

Example 47 includes the subject matter of any of Examples 42-46, and wherein the patient is one of a plurality of patients, the drug dosage determination server further comprising means for obtaining the patient physiological data from physiological sensors associated with the plurality of patients; and means for aggregating the obtained patient physiological data to produce aggregated physiological data, and wherein the means for determining the drug dosage for the patient comprises means for determining the drug dosage based on the aggregated physiological data.

Example 48 includes the subject matter of any of Examples 42-47, and further including means for determining at least one of a type of drug to be prescribed, a dosage amount of the drug to be prescribed, and a treatment schedule for the drug to be prescribed, based additionally on the aggregated patient physiological data and at least one predefined heuristic.

Example 49 includes the subject matter of any of Examples 42-48, and further including means for obtaining health history data associated with the patient, and wherein the means for determining the drug dosage for the patient comprises means for determining a drug dosage based on the obtained physiological data and the health history data.

Example 50 includes the subject matter of any of Examples 42-49, and further including means for determining at least one of a type of drug to be prescribed, a dosage amount of the drug to be prescribed, and a treatment schedule for the drug to be prescribed, based additionally on the obtained health history data associated with the patient and at least one predefined heuristic.

Example 51 includes the subject matter of any of Examples 42-50, and further including means for obtaining schedule data associated with the patient, and wherein the means for determining the drug dosage for the patient comprises means for determining a drug dosage based on the obtained physiological data and the schedule data.

Example 52 includes the subject matter of any of Examples 42-51, and further including means for determining at least one of a type of drug to be prescribed, a dosage amount of the drug to be prescribed, and a treatment schedule for the drug to be prescribed, based additionally on the schedule data associated with the patient and at least one predefined heuristic.

Example 53 includes the subject matter of any of Examples 42-52, and wherein the means for determining the drug dosage for the patient comprises means for determining a type of drug to be prescribed to the patient, based on the obtained patient physiological data and at least one predefined heuristic.

Example 54 includes the subject matter of any of Examples 42-53, wherein the means for determining the drug dosage for the patient comprises means for determining a dosage amount of a drug to be prescribed to the patient, based on the obtained patient physiological data and at least one predefined heuristic.

Example 55 includes the subject matter of any of Examples 42-54, and wherein the means for determining the drug dosage for the patient comprises means for determining a treatment schedule associated with a drug to be prescribed to the patient, based on the obtained patient physiological data and at least one predefined heuristic.

Example 56 includes the subject matter of any of Examples 42-55, and further including means for determining health threat data for the drug dosage; and means for adjusting the drug dosage instructions based on the health threat data.

Example 57 includes the subject matter of any of Examples 42-56, and further including means for identifying a health threat based on the patient physiological data.

Example 58 includes the subject matter of any of Examples 42-57, and wherein the patient is one of a plurality of patients, the drug dosage determination server further comprising means for identifying a health threat based on aggregated physiological data associated with the plurality of patients.

Example 59 includes the subject matter of any of Examples 42-58, and further including means for identifying a health threat based on health history data associated with the patient.

Example 60 includes the subject matter of any of Examples 42-59, and further including means for identifying a health threat based on schedule data associated with the patient.

Example 61 includes the subject matter of any of Examples 42-60, and wherein the means for generating the drug dosage instructions further comprises means for generating three dimensional drug printing instructions usable by a three dimensional printer to generate the drug.

Example 62 includes a drug dispenser device for providing customized drugs to a patient, the drug dispenser device comprising a communication module to receive drug dosage instructions from a drug dosage determination server; an authentication module to authenticate a patient based on authentication credentials; a dose generator module to generate the drug based on the drug dosage instructions in response to a determination that the patient is authenticated; and a dose dispenser module to dispense the generated drug.

Example 63 includes the subject matter of Example 62, and wherein the authentication module is further to lock the drug dispenser device prior to the determination of whether the patient is authenticated.

Example 64 includes the subject matter of any of Examples 62 and 63, and wherein the communication module is further to receive patient authentication data from the drug dosage determination server; and the authentication module is further to prompt the patient for authentication credentials, receive the authentication credentials in response to the prompt, and compare the patient authentication data to the authentication credentials to determine whether the patient is authenticated.

Example 65 includes the subject matter of any of Examples 62-64, and wherein the communication module is further to receive patient authentication data from the drug dosage determination server; and the authentication module is further to determine, from the patient authentication data, whether the patient satisfies a predefined age threshold and generate, in response to a determination that the patient satisfies the predefined age threshold, a prompt for parental authentication.

Example 66 includes the subject matter of any of Examples 62-65, and wherein the authentication module is further to receive at least one of a username, a password, and a personal identification number as the authentication credentials.

Example 67 includes the subject matter of any of Examples 62-66, and wherein the authentication module is further to receive biometric data as the authentication credentials.

Example 68 includes the subject matter of any of Examples 62-67, and wherein the authentication module is further to receive parental authentication credentials as at least a part of the authentication credentials.

Example 69 includes the subject matter of any of Examples 62-68, and wherein the authentication module is further to receive the authentication credentials from a radio frequency identification (RFID) device.

Example 70 includes the subject matter of any of Examples 62-69, and further including an alert module to determine whether the drug dispenser device has been tampered with; and generate an alert in response to a determination that the drug dispenser device has been tampered with.

Example 71 includes the subject matter of any of Examples 62-70, and further including an alert module to generate an alert in response to a determination that the drug dosage instructions have been changed due to a health threat.

Example 72 includes the subject matter of any of Examples 62-71, and wherein the dose generator module is further to generate the drug based on a drug type included in the drug dosage instructions.

Example 73 includes the subject matter of any of Examples 62-72, and wherein the dose generator module is further to generate the drug at a dosage amount included in the drug dosage instructions.

Example 74 includes the subject matter of any of Examples 62-73, and wherein the dose generator module is further to generate the drug based on a treatment schedule included in the drug dosage instructions.

Example 75 includes the subject matter of any of Examples 62-74, and wherein the dose generator module further comprises a three dimensional printer controller module to three dimensionally print the drug based on the drug dosage instructions.

Example 76 includes the subject matter of any of Examples 62-75, and wherein the authentication module is further to unlock the drug dispenser device in response to a determination that the patient is authenticated.

Example 77 includes the subject matter of any of Examples 62-76, and wherein the communication module is further to transmit a drug dosage dispense acknowledgement to the drug dosage determination server after the drug has been dispensed.

Example 78 includes a method for providing customized drugs to a patient, the method comprising receiving, by a drug dispenser device, drug dosage instructions from a drug dosage determination server; authenticating, by the drug dispenser device, the patient based on authentication credentials; generating, by the drug dispenser device, the drug based on the drug dosage instructions, in response to a determination that the patient is authenticated; and dispensing, by the drug dispenser device, the generated drug.

Example 79 includes the subject matter of Example 78, and further including locking, by the drug dispenser device, the drug dispenser device prior to the determination of whether the patient is authenticated.

Example 80 includes the subject matter of any of Examples 78 and 79, and further including receiving, by the drug dispenser device, patient authentication data from the drug dosage determination server; prompting, by the drug dispenser device, the patient for authentication credentials; receiving, by the drug dispenser device, the authentication credentials in response to the prompt; and comparing, by the drug dispenser device, the patient authentication data to the authentication credentials to determine whether the patient is authenticated.

Example 81 includes the subject matter of any of Examples 78-80, and further including receiving, by the drug dispenser device, patient authentication data from the drug dosage determination server; determining, by the drug dispenser device, from the patient authentication data, whether the patient satisfies a predefined age threshold; and generating, by the drug dispenser device, in response to a determination that the patient satisfies the predefined age threshold, a prompt for parental authentication.

Example 82 includes the subject matter of any of Examples 78-81, and further including receiving, by the drug dispenser device, at least one of a username, a password, and a personal identification number as the authentication credentials.

Example 83 includes the subject matter of any of Examples 78-82, and further including receiving, by the drug dispenser device, biometric data as the authentication credentials.

Example 84 includes the subject matter of any of Examples 78-83, and further including receiving, by the drug dispenser device, parental authentication credentials as at least a part of the authentication credentials.

Example 85 includes the subject matter of any of Examples 78-84, and further including receiving, by the drug dispenser device, the authentication credentials from a radio frequency identification (RFID) device.

Example 86 includes the subject matter of any of Examples 78-85, and further including determining, by the drug dispenser device, whether the drug dispenser device has been tampered with; and generating, by the drug dispenser device, an alert in response to a determination that the drug dispenser device has been tampered with.

Example 87 includes the subject matter of any of Examples 78-86, and further including determining, by the drug dispenser device, whether the drug dosage instructions have been changed due to a health threat; and generating, by the drug dispenser device, an alert in response to a determination that the drug dosage instructions have been changed due to a health threat.

Example 88 includes the subject matter of any of Examples 78-87, and further including generating, by the drug dispenser device, the drug based on a drug type included in the drug dosage instructions.

Example 89 includes the subject matter of any of Examples 78-88, and further including generating, by the drug dispenser device, the drug at a dosage amount included in the drug dosage instructions.

Example 90 includes the subject matter of any of Examples 78-89, and, further including generating, by the drug dispenser device, the drug based on a treatment schedule included in the drug dosage instructions.

Example 91 includes the subject matter of any of Examples 78-90, and further including three dimensionally printing, by the drug dispenser device, the drug based on the drug dosage instructions.

Example 92 includes the subject matter of any of Examples 78-91, and further including unlocking, by the drug dispenser device, the drug dispenser device in response to a determination that the patient is authenticated.

Example 93 includes the subject matter of any of Examples 78-92, and further including transmitting, by the drug dispenser device, a drug dosage dispense acknowledgement to the drug dosage determination server after the drug has been dispensed.

Example 94 includes one or more computer-readable storage media comprising a plurality of instructions that, when executed, cause a drug dispenser device to perform the method of any of Examples 78-93.

Example 95 includes a drug dispenser device providing customized drugs to a patient, the drug dispenser device comprising means for receiving drug dosage instructions from a drug dosage determination server; means for authenticating the patient based on authentication credentials; means for generating the drug based on the drug dosage instructions, in response to a determination that the patient is authenticated; and means for dispensing the generated drug.

Example 96 includes the subject matter of Example 95, and further including means for locking the drug dispenser device prior to the determination of whether the patient is authenticated.

Example 97 includes the subject matter of any of Examples 95 and 96, and further including means for receiving patient authentication data from the drug dosage determination server; means for prompting the patient for authentication credentials; means for receiving the authentication credentials in response to the prompt; and means for comparing the patient authentication data to the authentication credentials to determine whether the patient is authenticated.

Example 98 includes the subject matter of any of Examples 95-97, and further including means for receiving patient authentication data from the drug dosage determination server; means for determining, from the patient authentication data, whether the patient satisfies a predefined age threshold; and means for generating, in response to a determination that the patient satisfies the predefined age threshold, a prompt for parental authentication.

Example 99 includes the subject matter of any of Examples 95-98, and further including means for receiving at least one of a username, a password, and a personal identification number as the authentication credentials.

Example 100 includes the subject matter of any of Examples 95-99, and further including means for receiving biometric data as the authentication credentials.

Example 101 includes the subject matter of any of Examples 95-100, and further including means for receiving parental authentication credentials as at least a part of the authentication credentials.

Example 102 includes the subject matter of any of Examples 95-101, and further including means for receiving the authentication credentials from a radio frequency identification (RFID) device.

Example 103 includes the subject matter of any of Examples 95-102, and further including means for determining whether the drug dispenser device has been tampered with; and means for generating an alert in response to a determination that the drug dispenser device has been tampered with.

Example 104 includes the subject matter of any of Examples 95-103, and further including means for determining whether the drug dosage instructions have been changed due to a health threat; and means for generating an alert in response to a determination that the drug dosage instructions have been changed due to a health threat.

Example 105 includes the subject matter of any of Examples 95-104, and further including means for generating the drug based on a drug type included in the drug dosage instructions.

Example 106 includes the subject matter of any of Examples 95-105, and further including means for generating the drug at a dosage amount included in the drug dosage instructions.

Example 107 includes the subject matter of any of Examples 95-106, and further including means for generating the drug based on a treatment schedule included in the drug dosage instructions.

Example 108 includes the subject matter of any of Examples 95-107, and further including means for three dimensionally printing the drug based on the drug dosage instructions.

Example 109 includes the subject matter of any of Examples 95-108, and further including means for unlocking the drug dispenser device in response to a determination that the patient is authenticated.

Example 110 includes the subject matter of any of Examples 95-109, and further including means for transmitting a drug dosage dispense acknowledgement to the drug dosage determination server after the drug has been dispensed.

1. A drug dosage determination server for determining a drug dosage for a patient, the drug dosage determination server comprising:
a physiological data aggregator module to obtain patient physiological data from physiological sensors associated with the patient;
a drug dosage determination module to determine a drug dosage for the patient based on the obtained patient physiological data and to generate drug dosage instructions for a drug dispenser device, based on the determined drug dosage, wherein the drug dosage instructions are usable by the drug dispenser device to generate a drug; and
a communication module to transmit the drug dosage instructions to the drug dispenser device.

2. The drug dosage determination server of claim 1, wherein the physiological sensors comprise a patient computing device.

3. The drug dosage determination server of claim 1, wherein the patient is one of a plurality of patients, and the physiological data aggregator module is further to obtain patient physiological data associated with the plurality of patients and aggregate the obtained patient physiological data to produce aggregated physiological data, and
wherein to determine the drug dosage for the patient comprises to determine a drug dosage based on the aggregated physiological data.

4. The drug dosage determination server of claim 3, wherein the drug dosage determination module is further to determine at least one of a type of drug to be prescribed, a dosage amount of the drug to be prescribed, and a treatment schedule for the drug to be prescribed based additionally on the aggregated patient physiological data and at least one predefined heuristic.

5. The drug dosage determination server of claim 1, wherein the physiological data aggregator module is further to obtain health history data associated with the patient, and
wherein to determine the drug dosage for the patient comprises to determine a drug dosage based on the obtained physiological data and the health history data.

6. The drug dosage determination server of claim 5, wherein the drug dosage determination module is further to determine at least one of a type of drug to be prescribed, a dosage amount of the drug to be prescribed, and a treatment schedule for the drug to be prescribed based additionally on the obtained health history data associated with the patient and at least one predefined heuristic.

7. The drug dosage determination server of claim 1, wherein the physiological data aggregator module is further to obtain schedule data associated with the patient, and
wherein to determine the drug dosage for the patient comprises to determine a drug dosage based on the obtained physiological data and the schedule data.

8. The drug dosage determination server of claim 7, wherein the drug dosage determination module is further to determine at least one of a type of drug to be prescribed, a dosage amount of the drug to be prescribed, and a treatment schedule for the drug to be prescribed, based additionally on the schedule data associated with the patient and at least one predefined heuristic.

9. The drug dosage determination server of claim 1, further comprising:
a health threat analysis module to determine health threat data for the drug dosage; and
wherein the drug dosage determination module is further to adjust the drug dosage instructions based on the health threat data.

10. One or more computer-readable storage media comprising a plurality of instructions that, in response to being executed, result in a drug dosage determination server:
obtaining patient physiological data from physiological sensors associated with the patient;
determining the drug dosage for the patient based on the obtained patient physiological data;
generating drug dosage instructions for a drug dispenser device, based on the determined drug dosage, wherein the drug dosage instructions are usable by the drug dispenser device to generate a drug; and
transmitting the drug dosage instructions to the drug dispenser device.

11. The one or more computer-readable storage media of claim 10, wherein the patient is one of a plurality of patients, the one or more computer-readable storage media further comprising a plurality of instructions that, in response to being executed, result in the drug dosage determination server:
obtaining the patient physiological data from physiological sensors associated with the plurality of patients; and
aggregating the obtained patient physiological data to produce aggregated physiological data, and
wherein determining the drug dosage for the patient comprises determining the drug dosage based on the aggregated physiological data.

12. The one or more computer-readable storage media of claim 11, further comprising a plurality of instructions that, in response to being executed, result in the drug dosage determination server determining at least one of a type of drug to be prescribed, a dosage amount of the drug to be prescribed, and a treatment schedule for the drug to be prescribed, based additionally on the aggregated patient physiological data and at least one predefined heuristic.

13. The one or more computer-readable storage media of claim 10, further comprising a plurality of instructions that, in response to being executed, result in the drug dosage determination server obtaining health history data associated with the patient, and
wherein determining the drug dosage for the patient comprises determining a drug dosage based on the obtained physiological data and the health history data.

14. The one or more computer-readable storage media of claim 13, further comprising a plurality of instructions that, in response to being executed, result in the drug dosage determination server determining at least one of a type of drug to be prescribed, a dosage amount of the drug to be prescribed, and a treatment schedule for the drug to be prescribed, based additionally on the obtained health history data associated with the patient and at least one predefined heuristic.

15. The one or more computer-readable storage media of claim 10, further comprising a plurality of instructions that, in response to being executed, result in the drug dosage determination server obtaining schedule data associated with the patient, and
wherein determining the drug dosage for the patient comprises determining a drug dosage based on the obtained physiological data and the schedule data.

16. The one or more computer-readable storage media of claim 15, further comprising a plurality of instructions that, in response to being executed, result in the drug dosage determination server determining at least one of a type of drug to be prescribed, a dosage amount of the drug to be prescribed, and a treatment schedule for the drug to be prescribed, based additionally on the schedule data associated with the patient and at least one predefined heuristic.

17. The one or more computer-readable storage media of claim 10, further comprising a plurality of instructions that, in response to being executed, result in the drug dosage determination server:
determining health threat data for the drug dosage; and
adjusting the drug dosage instructions based on the health threat data.

18. A method for determining a drug dosage for a patient, the method comprising:
obtaining, by a drug dosage determination server, patient physiological data from physiological sensors associated with the patient;
determining, by the drug dosage determination server, the drug dosage for the patient based on the obtained patient physiological data;
generating, by the drug dosage determination server, drug dosage instructions for a drug dispenser device, based on the determined drug dosage, wherein the drug dosage instructions are usable by the drug dispenser device to generate a drug; and
transmitting, by the drug dosage determination server, the drug dosage instructions to the drug dispenser device.

19. The method of claim 18, wherein the patient is one of a plurality of patients, the method further comprising:
obtaining, by the drug dosage determination server, the patient physiological data from physiological sensors associated with the plurality of patients; and
aggregating, by the drug dosage determination server, the obtained patient physiological data to produce aggregated physiological data, and
wherein determining the drug dosage for the patient comprises determining the drug dosage based on the aggregated physiological data.

20. The method of claim 19, further comprising determining, by the drug dosage determination server, at least one of a type of drug to be prescribed, a dosage amount of the drug to be prescribed, and a treatment schedule for the drug to be prescribed, based additionally on the aggregated patient physiological data and at least one predefined heuristic.

21. The method of claim 18, further comprising obtaining, by the drug dosage determination server, health history data associated with the patient, and
wherein determining the drug dosage for the patient comprises determining a drug dosage based on the obtained physiological data and the health history data.

22. The method of claim 21, further comprising determining, by the drug dosage determination server, at least one of a type of drug to be prescribed, a dosage amount of the drug to be prescribed, and a treatment schedule for the drug to be prescribed, based additionally on the obtained health history data associated with the patient and at least one predefined heuristic.

23. The method of claim 18, further comprising obtaining, by the drug dosage determination server, schedule data associated with the patient, and
wherein determining the drug dosage for the patient comprises determining a drug dosage based on the obtained physiological data and the schedule data.

24. The method of claim 23, further comprising determining, by the drug dosage determination server, at least one of a type of drug to be prescribed, a dosage amount of the drug to be prescribed, and a treatment schedule for the drug to be prescribed, based additionally on the schedule data associated with the patient and at least one predefined heuristic.

25. The method of claim 18, further comprising:
determining, by the drug dosage determination server, health threat data for the drug dosage; and
adjusting, by the drug dosage determination server, the drug dosage instructions based on the health threat data.
